(19) United States
(12) Patent Application Publication
(10) Pub. No.: US 2005/0207586 A1
(43) Pub. Date: Sep. 22, 2005

(54) Mobile communication earphone accommodating hearing aid with volume adjusting function and method thereof

(75) Inventors: Feng-Chi Lin, Taoyuan (TW); Yung-Pin Chen, Taoyuan (TW)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/086,478

(22) Filed: Mar. 21, 2005

(30) Foreign Application Priority Data
Mar. 22, 2004 (TW) 093107688

(51) Int. Cl. H04R 1/10

(52) U.S. Cl. 381/74; 455/575.2

(57) ABSTRACT

A earphone of the invention includes a microphone for converting a sound of a human to an audio signal, a power detector for detecting the power value of the audio signal and for generating a volume indicating value to indicate the volume of the sound, an audio signal amplifier for selectively amplifying the audio signal by a first amplification ratio or a second amplification ratio and for outputting an amplified audio signal, a wireless transmitter for converting the amplified audio signal to an RF signal and for transmitting the RF signal to a communication apparatus, a speaker for amplifying the audio signal by a predetermined amplification ratio and for converting the amplified audio signal into a corresponding sound to the human, and a memory for storing a volume threshold value. Moreover, the first amplification ratio is larger than the second amplification ratio.

### BACKGROUND OF THE INVENTION

1. Field of the Invention

The invention relates to a mobile communication earphone, especially to a mobile communication earphone that accommodates a hearing aid with volume adjusting function.

2. Description of the Prior Art

The communication apparatus is the most popular electronic products in recent years. In the usage of the communication apparatus, the user often cannot use the communication apparatus in a hand-held manner during driving or many other situations. Therefore, a mobile communication earphone that corresponds with the communication apparatus is usually used, too.

A hearing aid is usually used to aid hearing. Some hearing-impaired people can overcome a lot of inconvenience of life by using the hearing aid. However, present mobile communication earphones do not have the function for aiding hearing. If the hearing-impaired person wants to use the mobile communication earphone and the hearing aid at the same time, it is not only inconvenient when using but also costs a lot.

### SUMMARY OF THE INVENTION

The objective of the invention is to provide a mobile communication earphone and an audio processing method for processing the volume of a human and for transmitting that to the communication apparatus.

The other objective of the invention is to provide a mobile communication earphone with volume adjusting function and an audio processing method thereof for transmitting to the communication apparatus and helping the human to control the volume himself.

The other objective of the invention is to provide a mobile communication earphone that accommodates a hearing aid and an audio processing method thereof for providing for the hearing-impaired person.

Another objective of the invention is to provide a mobile communication earphone that accommodates a hearing aid with volume adjusting function and an audio processing method thereof for providing for the hearing-impaired person and helping the hearing-impaired person to control the volume himself when conducting the mobile communication.

The mobile communication earphone of the invention includes a microphone, a power detector, an audio signal amplifier, a mobile wireless transmitter, a speaker, and a memory. The microphone is used for converting a sound of a human to an audio signal. The power detector is used for detecting the power value of the audio signal and for generating a volume indicating value to indicate the volume of the sound. The audio signal amplifier is used for selectively amplifying the audio signal by different amplification ratios and outputting an amplified audio signal. The mobile wireless transmitter is used for selectively amplifying the audio signal by a predetermined amplification ratio, for converting the amplified audio signal to an RF signal, and for transmitting the RF signal to a communication apparatus. The speaker is used for converting the amplified audio signal into a corresponding sound to the human. The memory is used for storing a volume threshold value. When the volume indicating value is larger than the volume threshold value, the audio signal amplifier amplifies the audio signal by a first amplification ratio with a larger ratio. When the volume indicating value is smaller than the volume threshold value, the audio signal amplifier amplifies the audio signal by a second amplification ratio with a smaller ratio.

According to the invention, the power detector of the mobile communication earphone can detect the value of the audio signal and can compare that with the volume threshold value, and the audio signal amplifier can select the appropriate amplification ratio to amplify the audio signal. Therefore, the invention can process the audio signal, transmit the processed audio signal to the communication apparatus, and help the human to control the volume himself. Moreover, the mobile communication earphone of the invention can provide the function of a hearing aid, through the amplifier, to the speaker. The mobile communication earphone of the invention is very convenient for a hearing-impaired person.

The advantage and spirit of the invention may be understood by the following recitations together with the appended drawings.

### BRIEF DESCRIPTION OF THE APPENDED DRAWINGS

FIG. 1 is a function block diagram of the mobile communication earphone according to the invention.

FIG. 2 is a schematic diagram of the volume indicating value and the volume threshold value shown in FIG. 1.

FIG. 3 is a flowchart of the audio processing method according to the invention.

FIG. 4 is a flowchart of the audio processing method of the other embodiment according to the invention.

### DETAILED DESCRIPTION OF THE INVENTION

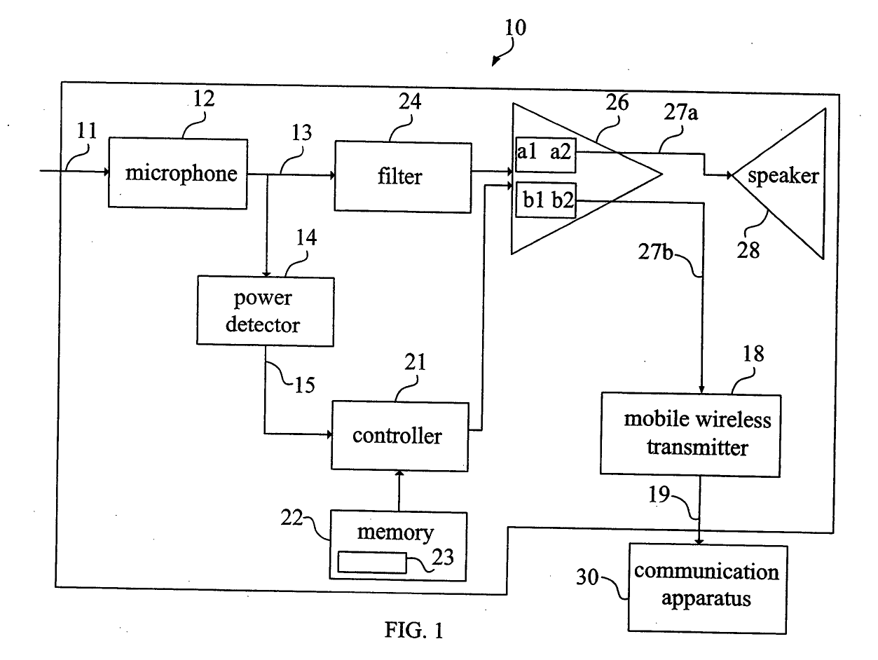

Please refer to FIG. 1. FIG. 1 is a function block diagram of the mobile communication earphone 10 according to the invention. The mobile communication earphone 10 includes a microphone 12, a power detector 14, a mobile wireless transmitter 18, a controller 21, a memory 22, a filter 24, an audio signal amplifier 26, and a speaker 28. The mobile communication earphone 10 is used with a communication apparatus 30.

The microphone 12 is used for sensing and receiving a sound 11 of a human, for converting the sound 11 to an audio signal 13, and for transmitting the audio signal 13 to the power detector 14 and the filter 24. The power detector 14 is used for detecting the power value of the audio signal 13 in terms of dB and generating a volume indicating value 15 to indicate the volume of the sound. The volume indicating value 15 is generated by calculating a moving average value of the audio signals 13. The memory 22 is used for storing a volume threshold value 23. The controller 21 is used for comparing the volume indicating value 15 with the volume threshold value 23. The filter 24 is used for filtering the audio signal 13 inputted to the audio signal amplifier 26. The speaker 28 is used for amplifying the audio signal 13 by a predetermined amplification ratio and for converting the amplified audio signal into a corresponding sound to the human.

The audio signal amplifier 26 has two amplification units 26a, 26b. The amplification units 26a and 26b respectively have more than one amplification ratio. The amplification units 26a and 26b respectively receive the audio signal 13, selectively amplify the audio signal 13 by different amplification ratios, and output an amplified audio signal 27a, 27b. The amplified audio signal 27a outputted by the amplification unit 26a is outputted to the speaker 28. The amplified audio signal 27b outputted by the amplification unit 26b is outputted to the mobile wireless transmitter 18. The speaker 28 converts the amplified audio signal 27a into a corresponding sound to the human. The mobile wireless transmitter 18 converts the amplified audio signal 27b to an RF signal 19 and transmits the RF signal 19 to the communication apparatus 30.

In an embodiment, the mobile wireless transmitter 18 is a Bluetooth transmitter/receiver, and the communication apparatus 30 also includes a corresponding Bluetooth transmitter/receiver (not shown). The RF signal 19 from the mobile wireless transmitter 18 is received by the Bluetooth transmitter/ receiver of the communication apparatus 30 for enabling the human to use the communication apparatus via the mobile communication earphone 10 of the invention.

In an embodiment, the amplification unit 26a of the audio signal amplifier 26 has two kinds of amplification ratios, and the first amplification ratio al is larger than the second amplification ratio a2. The amplification unit 26b also has two kinds of amplification ratios, and the first amplification ratio b1 is larger than the second amplification ratio b2. When the volume indicating value 15 is larger than the volume threshold value 23, the amplification unit 26a adjusts the audio signal by the first amplification ratio a1. When the volume indicating value 15 is smaller than the volume threshold value 23, the audio signal amplifier 26 adjusts the audio signal by the second amplification ratio a2. When the volume indicating value 15 is larger than the volume threshold value 23, the amplification unit 26b adjusts the audio signal by the second amplification ratio. When the volume indicating value 15 is smaller than the volume threshold value 23, the audio signal amplifier 26 adjusts the audio signal by the first amplification ratio.

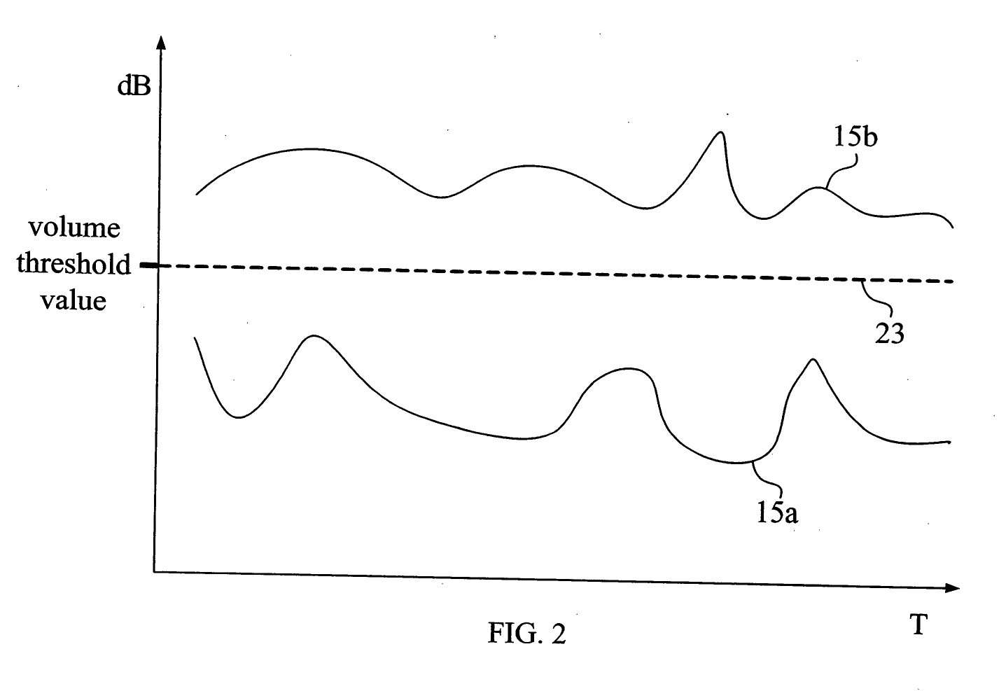

Please refer to FIG. 2. FIG. 2 is a schematic diagram of the volume indicating value 15 and the volume threshold value 23 shown in FIG. 1. As shown in FIG. 2, the dotted line represents the decibel of the volume threshold value 23, and the two curves respectively represent two volume indicating values 15a and 15b of the audio signal 13. The volume of the human with the volume indicating value 15b is higher than the human with the volume indicating value 15a. In an embodiment, the volume threshold value 23 represents the average volume in general. When the volume of a human is lower than the common volume, the volume indicating value 15a is smaller than the volume threshold value 23. Comparatively, when the volume of the human is raised because of impaired hearing or other reasons, the volume indicating value 15b is larger than the volume threshold value 23. The controller 21 judges the volume of the human according to the volume indicating value 15 and the volume threshold value 23 stored in the memory 22, and then it determines the amplification ratio for the audio signal 13.

When the volume of the human is lower than the common volume, the amplification unit 26a adjusts the audio signal with the second amplification ratio a2, which is correspondingly smaller, and outputs the amplified audio signal to the speaker 28 for transmitting to the ear of the human. On the other hand, the amplification unit 26b adjusts the audio signal with the first amplification ratio b1, which is correspondingly larger, and outputs the amplified audio signal to the mobile wireless transmitter 18 for transmitting to the communication apparatus 30. When the volume of the human is higher than the common volume, the audio signal amplifier 26 adjusts the audio signal with the first amplification ratio a1, which is correspondingly larger, and outputs the amplified audio signal to the speaker 28 for transmitting to the ear of the human. The amplification unit 26b adjusts the audio signal with the second amplification ratio b2, which is correspondingly smaller, and outputs the amplified audio signal to the mobile wireless transmitter 18 for transmitting to the communication apparatus 30. When the human speaks to someone with a higher volume, the mobile communication earphone 10 can amplify the audio signal with a correspondingly smaller ratio and transmit the amplified audio signal to the communication apparatus 30, so that the other user communicating by the communication apparatus 30 doesn't feel the audio sound is too harsh to the ear. On the other hand, when the human speaks to someone with higher volume, the mobile communication earphone 10 can amplify the audio signal with a correspondingly larger ratio and transmit the amplified audio signal back to the ear of the human to remind the speaker to reduce his/her volume.

The mobile communication earphone 10 of the invention can further be the hearing aid for the hearing-impaired person. The functioning method of the hearing aid of the mobile communication earphone 10 according to the invention will be described in the following by FIG. 1. The microphone 12 of the mobile communication earphone 10 converts the sound from the environment of the hearing-impaired person to audio signals and transmits the audio signal to the speaker 28. After the speaker 28 amplifies the audio signals by a predetermined amplification ratio, the speaker converts the amplified audio signal to the corresponding sound to the hearing-impaired person. In an embodiment, the hearing-impaired person can select the predetermined amplification ratio according to the hearing-impaired level himself.

The above function of the hearing aid may coexist with the function of the mobile communication earphone. In an embodiment, the user of the mobile communication earphone is a hearing-impaired person, and the communication apparatus 30 is a mobile phone. The hearing-impaired person is the human and wears the mobile communication earphone 10. After going through the above-mentioned processes, the Bluetooth transmitter/receiver of the mobile communication earphone transmits the audio sound of the human to the communication apparatus 30 and receives the returned audio sound from the communication apparatus 30 for the user. The mobile communication earphone 10 switches between the above two functions according to whether the communication apparatus is in communication. When the communication apparatus 30 is in communication, the mobile communication earphone 10 provides the earphone function of the mobile phone. At this time, when the volume indicating value 15 is larger than the volume threshold value 23, the amplification unit 26b amplifies the audio signal by the second amplification ratio b2. When the volume indicating value 15 is smaller than the volume threshold value 23, the amplification unit 26b amplifies the audio signal by the first amplification ratio b1. Furthermore, when the communication apparatus is not in communication, the mobile communication earphone 10 utilizes the above hearing aid method to amplify the sound of the environment where the user is situated, so as to achieve the function of hearing aid.

In another embodiment of the invention, the mobile communication earphone 10 has both the function of hearing aid and the function of mobile communication earphone, and it can also help the hearing-impaired person to control the volume himself. Generally, the hearing-impaired person has bad hearing, so he/she cannot determine his/her own volume accurately. Therefore, when the hearing-impaired person speaks, he/she always tends to raise the volume. In this embodiment, the configuration of the hardware is the same with the mobile communication earphone 10 shown in FIG. 1. When the communication apparatus 30 is in communication, the mobile communication earphone 10 provides the earphone function of mobile phone and helps the hearing-impaired person to control the volume himself. In other words, after detecting the volume from the user, the mobile communication earphone processes the audio signal by the amplification unit 26b for transmitting to the communication apparatus 30 and processes the audio signal by the amplification unit 26a for transmitting to the speaker. Moreover, when the communication apparatus 30 is not in communication, the mobile communication earphone 10 utilizes the above-mentioned hearing aid method to amplify the sound of the environment where the user is situated, so as to achieve the function of hearing aid.

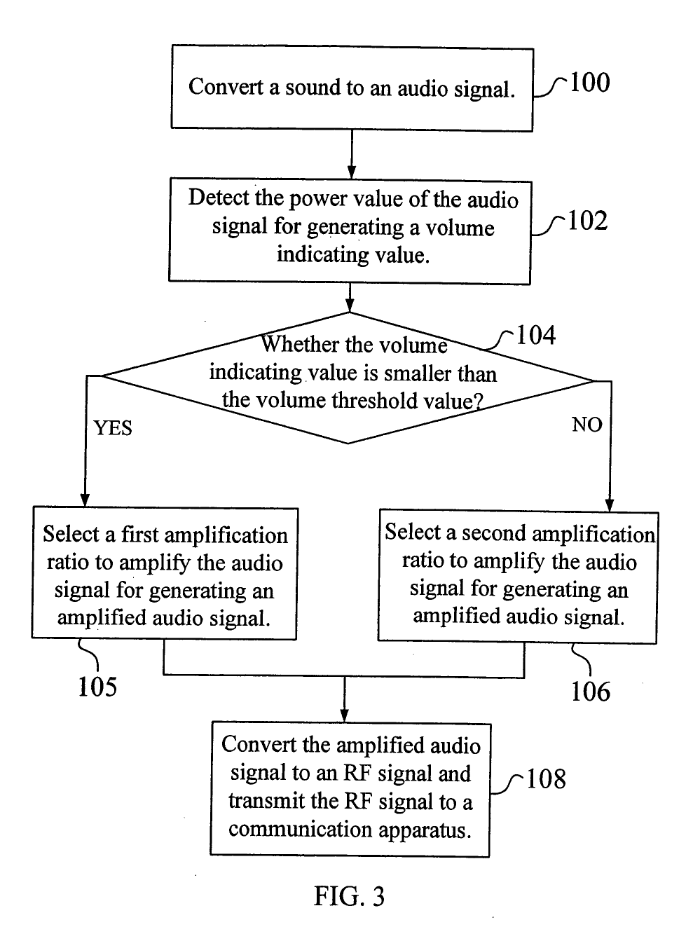

Please refer to FIG. 3. FIG. 3 is a flowchart of the audio processing method according to the invention. The invention also provides an audio processing method for processing an audio sound of the user to transmit to a communication apparatus. As shown in FIG. 3, the steps are described in the following:

Step 100: Convert a sound of a human to an audio signal. In an embodiment, this step can be completed by a microphone. The audio signal can be processed by different amplification ratios to be an amplified audio signal. In an embodiment, there are two kinds of amplification ratios, and the first amplification ratio is larger than the second amplification ratio.

Step 102: Detect the power value of the audio signal for generating a volume indicating value. The volume indicating value is a moving average value for indicating the average volume of the sound generated by the human in a past time span, and the volume indicating value is expressed in terms of dB.

Step 104: Compare the volume indicating value to a volume threshold value in terms of dB. The volume threshold value is the average power level of the sounds generated by a hearing-impaired person, and the volume threshold value is expressed in terms of dB. When the volume indicating value is smaller than the volume threshold value, go to step 105, but when the volume indicating value is larger than the volume threshold value, go to step 106.

Step 105: Select a first amplification ratio, which is correspondingly larger, to amplify the audio signal for generating an amplified audio signal, then go to step 108. Step 106: Select a second amplification ratio, which is correspondingly smaller, to amplify the audio signal for generating an amplified audio signal, then go to step 108.

Step 108: Convert the amplified audio signal to an RF signal, and transmit the RF signal to a communication apparatus.

The audio processing method shown in FIG. 3 can be applied to the mobile communication earphone of the communication apparatus for detecting the volume of the user and for adjusting the audio signal to the communication apparatus when the volume of the user is overly high.

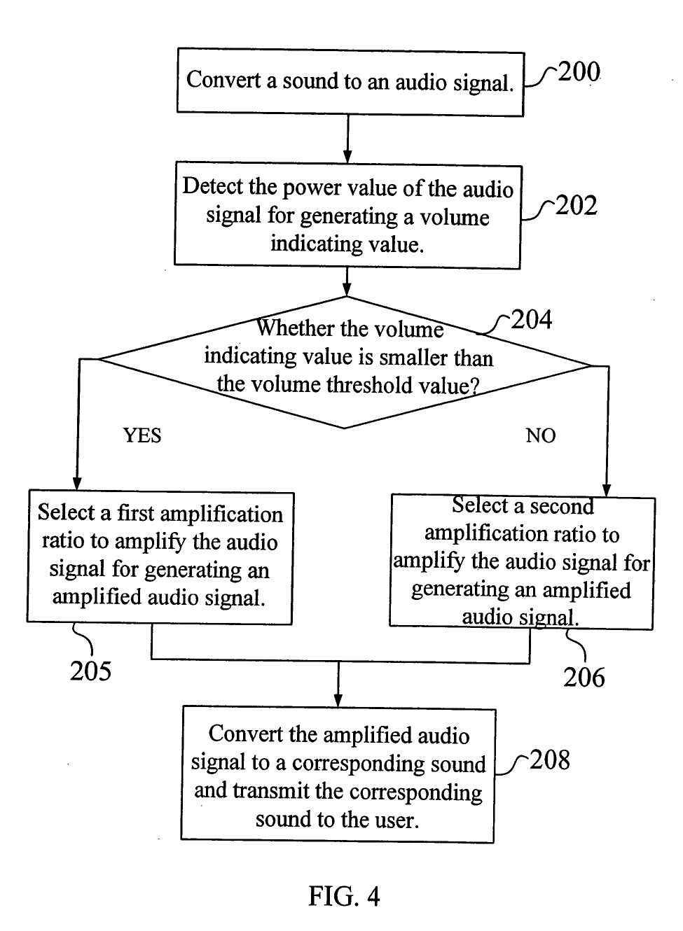

Please refer to FIG. 4. FIG. 4 is a flowchart of the audio processing method of the other embodiment according to the invention. The steps 200 to 202 shown in FIG. 4 are similar to the steps 100 to 102 shown in FIG. 3, so these steps won't be described again, and the other steps shown in FIG. 4 are described in the following:

Step 204: Compare the volume indicating value to a volume threshold value in terms of dB. When the volume indicating value is smaller than the volume threshold value, go to step 205, but when the volume indicating value is larger than the volume threshold value, go to step 206.

Step 205: Select a second amplification ratio to amplify the audio signal for generating an amplified audio signal, then go to step 208.

Step 206: Select a first amplification ratio to amplify the audio signal for generating an amplified audio signal, then go to step 208.

Step 208: Convert the amplified audio signal to a corresponding sound and transmit the corresponding sound to the user.

The audio processing method shown in FIG. 4 can be applied to the mobile communication earphone of the communication apparatus for detecting the volume of the user and for adjusting the audio signal to the user when the volume of the user is overly high, so as to help the user to control the volume himself.

According to the invention, the power detector of the mobile communication earphone can detect the value of the audio signal by comparing the signal with the volume threshold value, and the audio signal amplifier can select the appropriate amplification ratio for amplifying the audio signal. Therefore, the invention can process the audio signal, transmit the processed audio signal to the communication apparatus, and help the human to control the volume himself. Moreover, the mobile communication earphone of the invention can provide the function of hearing aid to the speaker. Moreover, according to the invention, when the mobile communication earphone accommodating a hearing aid with volume adjusting function is used by the hearing-impaired person, the hearing-impaired person can control the volume himself in communication without using the mobile communication earphone and the hearing aid at the same time. Therefore, the mobile communication earphone of the invention is very convenient for the hearing-impaired person.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An earphone comprising:
a microphone for converting a sound of a human to an audio signal;
a power detector for detecting the power of the audio signal and generating a volume indicating value to indicate the volume of the sound;
an amplifier for selectively amplifying the audio signal by one of a first amplification ratio and a second amplification ratio, and then outputting an amplified audio signal, the first amplification ratio being larger than the second amplification ratio;
a wireless transmitter for converting the amplified audio signal to a wireless signal and transmitting the wireless signal to a communication apparatus;
a speaker for selectively converting the audio signal into a corresponding sound; and
a memory for storing a volume threshold value;
wherein when the volume indicating value is larger than the volume threshold value, the audio signal amplifier amplifies the audio signal by the second amplification ratio; and when the volume indicating value is smaller than the volume threshold value, the audio signal amplifier amplifies the audio signal by the first amplification ratio.

2. The earphone of claim 1, wherein the microphone further can convert a sound from the environment where the human is situated to a hearing aid signal, and the speaker converts the hearing aid signal into a corresponding environment sound.

3. The earphone of claim 2, wherein the earphone transmits the wireless signal when the communication apparatus is activated, and outputs the corresponding environment sound when the communication apparatus is idle.

4. The earphone of claim 2, wherein the speaker further amplifies the hearing aid signal by a predetermined amplification ratio when converting the hearing aid signal into the corresponding environment sound.

5. The earphone of claim 1, wherein the speaker further amplifies the audio signal by a predetermined amplification ratio when converting the audio signal into the corresponding sound.

6. The earphone of claim 1, wherein the wireless transmitter is a Bluetooth transmitter/receiver and the communication apparatus also comprises a corresponding Bluetooth transmitter/receiver.

7. A earphone comprising:
a microphone for converting a sound of a human to an audio signal;
an audio signal amplifier for selectively amplifying the audio signal by a first amplification ratio or a second amplification ratio, and outputting an amplified audio signal, the first amplification ratio being larger than the second amplification ratio;
a power detector for detecting the power of the audio signal and generating a volume indicating value to indicate the volume of the sound;
a wireless transmitter for amplifying the audio signal by a predetermined amplification ratio, converting into a wireless signal, and transmitting the wireless signal to a communication apparatus;
a speaker for selectively converting the amplified audio signal to a corresponding sound; and
a memory for storing a volume threshold value;
wherein when the volume indicating value is larger than the volume threshold value, the audio signal amplifier amplifies the audio signal by the first amplification ratio; and when the volume indicating value is smaller than the volume threshold value, the audio signal amplifier amplifies the audio signal by the second amplification ratio.

8. The earphone of claim 7, wherein the microphone further can selectively convert a sound from the environment where the human is situated to a hearing aid signal, and the speaker converts the hearing aid signal into a corresponding environment sound.

9. The earphone of claim 8, wherein the earphone transmits the wireless signal when the communication apparatus is activate, and outputs the corresponding environment sound when the communication apparatus is idle.

10. The earphone of claim 7, the speaker further amplifies the hearing aid signal by a predetermined amplification ratio when converting the hearing aid signal into the corresponding environment sound.

11. The earphone of claim 7, wherein the speaker further amplifies the audio signal by a predetermined amplification ratio when converting the audio signal into the corresponding sound.

12. The earphone of claim 7, wherein the wireless transmitter is a Bluetooth transmitter/receiver and the communication apparatus also comprises a corresponding Bluetooth transmitter/receiver.

13. An audio processing method, comprising the following steps:
(1) converting a sound of a human to an audio signal;
(2) detecting the power of the audio signal for generating a volume indicating value;
(3) comparing the volume indicating value with a volume threshold value;
(4) according to the result of step (3), selectively amplifying the audio signal by a first amplification ratio or a second amplification ratio for generating an amplified audio signal, the first amplification ratio being larger than the second amplification ratio; and
(5) converting the amplified audio signal to an RF signal and transmitting the RF signal to a communication apparatus;
wherein the first amplification ratio is employed to amplify the audio signal when the volume indicating value is smaller than the volume threshold value; and the second amplification ratio is employed to amplify the audio signal when the volume indicating value is larger than the volume threshold value.

14. The audio processing method of claim 13, wherein the volume threshold value is the average power of the sound generated by a hearing-impaired person.

15. The audio processing method of claim 13, wherein the volume indicating value is a moving average for indicating the average volume of the sound generated by the human in a past time span.

16. The audio process method of claim 13, wherein the volume indicating value and the volume threshold value are both expressed in terms of dB.

17. An audio processing method, comprising the following steps:
(1) converting a sound of a human to an audio signal;
(2) detecting the power of the audio signal for generating a volume indicating value;
(3) comparing the volume indicating value with a volume threshold value;
(4) according to the result of step (3), selectively amplifying the audio signal by a first amplification ratio or a second amplification ratio for generating an amplified audio signal, the first amplification ratio being larger than the second amplification ratio; and
(5) converting the amplified audio signal to a corresponding sound;
wherein the first amplification ratio is employed to amplify the audio signal when the volume indicating value is larger than the volume threshold value; and the second amplification ratio is employed to amplify the audio signal when the volume indicating value is smaller than the volume threshold value.

18. The audio processing method of claim 17, wherein the volume threshold value is the average power of the sound generated by a hearing-impaired person.

19. The audio processing method of claim 17, wherein the volume indicating value is a moving average for indicating the average volume of the sound generated by the human in a past time span.

20. The audio process method of claim 17, wherein the volume indicating value and the volume threshold value are both expressed in terms of dB.
